(19) United States
(12) Patent Application Publication
(10) Pub. No.: US 2026/0223213 A1
(43) Pub. Date: Jul. 30, 2026

(54) METHODS FOR ESTABLISHING USER EQUIPMENT-HOSTED SERVICES

(71) Applicant: QUALCOMM Incorporated, San Diego, CA (US)

(72) Inventors: Karl Georg HAMPEL, Jersey City, NJ (US); Tien Viet NGUYEN, Bridgewater, NJ (US); Hua WANG, Basking Ridge, NJ (US); Hong CHENG, Basking Ridge, NJ (US); Miguel GRIOT, La Jolla, CA (US); Junyi LI, Greentown, PA (US)

(21) Appl. No.: 19/041,139

(22) Filed: Jan. 30, 2025

(51) Int. Cl. H04W 76/12; H04L 67/14

(52) U.S. Cl. CPC H04W 76/12; H04L 67/14

(57) ABSTRACT

Methods, systems, and devices for wireless communications are described. The techniques described herein may enable a UE to host a service using a public land mobile network (PLMN) domain name system (DNS) that is mapped to a global DNS. In some aspects, the UE may transmit a request to a service management function (SMF) for the UE to host the service. The SMF may verify the UE and may transmit a response indicating an acceptance or rejection of the request and an internet protocol (IP) address or a prefix associated with the IP address for the UE to use to host the service. The UE may accordingly establish the service and exchange one or more messages with a client device using the service.

### FIELD OF TECHNOLOGY

The following relates to wireless communications, including methods for establishing user equipment (UE)-hosted services.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting, via a wireless communications link, a first message including a request for the UE to host a first service, where the first message further includes resource record information associated with a domain name of the first service, receiving, responsive to the first message, a second message that indicates whether the request for the UE to host the first service is accepted, receiving, in accordance with the request being accepted and via a first internet protocol (IP) address that corresponds to a first protocol data unit (PDU) session established at the UE, a third message from a client device that is associated with the first service hosted at the UE, and transmitting, responsive to the third message and via the first IP address, a fourth message associated with the first service to the client device.

A UE for wireless communications is described. The UE may include one or more memories storing processor executable code, and one or more processors coupled with the one or more memories. The one or more processors may individually or collectively be operable to execute the code to cause the UE to transmit, via a wireless communications link, a first message including a request for the UE to host a first service, where the first message further includes resource record information associated with a domain name of the first service, receive, responsive to the first message, a second message that indicates whether the request for the UE to host the first service is accepted, receive, in accordance with the request being accepted and via a first IP address that corresponds to a first PDU session established at the UE, a third message from a client device that is associated with the first service hosted at the UE, and transmit, responsive to the third message and via the first IP address, a fourth message associated with the first service to the client device.

Another UE for wireless communications is described. The UE may include means for transmitting, via a wireless communications link, a first message including a request for the UE to host a first service, where the first message further includes resource record information associated with a domain name of the first service, means for receiving, responsive to the first message, a second message that indicates whether the request for the UE to host the first service is accepted, means for receiving, in accordance with the request being accepted and via a first IP address that corresponds to a first PDU session established at the UE, a third message from a client device that is associated with the first service hosted at the UE, and means for transmitting, responsive to the third message and via the first IP address, a fourth message associated with the first service to the client device.

A non-transitory computer-readable medium storing code for wireless communications is described. The code may include instructions executable by one or more processors to transmit, via a wireless communications link, a first message including a request for the UE to host a first service, where the first message further includes resource record information associated with a domain name of the first service, receive, responsive to the first message, a second message that indicates whether the request for the UE to host the first service is accepted, receive, in accordance with the request being accepted and via a first IP address that corresponds to a first PDU session established at the UE, a third message from a client device that is associated with the first service hosted at the UE, and transmit, responsive to the third message and via the first IP address, a fourth message associated with the first service to the client device.

Some examples of the method, UEs, and non-transitory computer-readable medium described herein may further include operations, features, means, or instructions for establishing, via the wireless communications link, the first PDU session, where the first message includes a PDU session establishment request message or includes a PDU session modification request message.

Some examples of the method, UEs, and non-transitory computer-readable medium described herein may further include operations, features, means, or instructions for receiving, responsive to the PDU session establishment request message or the PDU session modification request message, an indication that the first IP address may be associated with the first service.

Some examples of the method, UEs, and non-transitory computer-readable medium described herein may further include operations, features, means, or instructions for receiving, as part of a PDU session establishment procedure, a prefix for an IP address associated with the first PDU session and selecting the first IP address for the first service according to the prefix for the IP address, where the resource record information includes the first IP address associated with the first service.

In some examples of the method, UEs, and non-transitory computer-readable medium described herein, receiving the third message may include operations, features, means, or instructions for receiving, from the client device, a transport layer setup request message to establish a first transport layer between the client device and the UE.

Some examples of the method, UEs, and non-transitory computer-readable medium described herein may further include operations, features, means, or instructions for receiving, as part of a PDU session establishment procedure or a PDU session modification procedure for the first PDU session, an indication of a second IP address of a local domain name system (DNS) server, where the first message includes a second request for the resource record information to be hosted at the local DNS server, and where the first message includes an indication of the second IP address.

Some examples of the method, UEs, and non-transitory computer-readable medium described herein may further include operations, features, means, or instructions for transmitting a fifth message that includes modified resource record information for the domain name of the first service, the modified resource record information associating the domain name of the first service with a second IP address of a second PDU session and receiving, via the second IP address, a sixth message from the client device that may be associated with the first service hosted at the UE.

Some examples of the method, UEs, and non-transitory computer-readable medium described herein may further include operations, features, means, or instructions for transmitting the fifth message may be in response to a mobility of the UE.

In some examples of the method, UEs, and non-transitory computer-readable medium described herein, the first message includes an indication of a time window associated with an availability of the first service at the UE and transmitting the fourth message may be in response to the third message being received within the time window.

In some examples of the method, UEs, and non-transitory computer-readable medium described herein, the first message includes a second request to host a second service at the UE and includes second resource record information associated with a second domain name of the second service and the second message further indicates whether the second request to host the second service may be accepted.

In some examples of the method, UEs, and non-transitory computer-readable medium described herein, the resource record information includes the first IP address, a port number associated with the first service, a protocol type associated with the first service, a priority value associated with the first service, a weight value associated with the first service, or any combination thereof.

In some examples of the method, UEs, and non-transitory computer-readable medium described herein, the first service includes an application layer service, a web service, a gaming service, a peer-to-peer service, a life broadcast service, an artificial intelligence compute service, or any combination thereof and the first service uses a hyper text transfer protocol, a real-time transport protocol, or a real-time transport control protocol.

A method for wireless communications by a management entity is described. The method may include receiving, via a wireless communications link, a first message including a request for a UE to host a first service, where the first message further includes resource record information associated with a domain name of the first service, communicating, with a second management entity and in accordance with the resource record information for the domain name, to verify whether the UE is associated with a subscription to host the first service, and transmitting, responsive to the first message, a second message that indicates whether the request for the UE to host the first service is accepted, where the first service is associated with a first IP address that corresponds to a first PDU session established at the UE.

A management entity for wireless communications is described. The management entity may include one or more memories storing processor executable code, and one or more processors coupled with the one or more memories. The one or more processors may individually or collectively be operable to execute the code to cause the management entity to receive, via a wireless communications link, a first message including a request for a UE to host a first service, where the first message further includes resource record information associated with a domain name of the first service, communicate, with a second management entity and in accordance with the resource record information for the domain name, to verify whether the UE is associated with a subscription to host the first service, and transmit, responsive to the first message, a second message that indicates whether the request for the UE to host the first service is accepted, where the first service is associated with a first IP address that corresponds to a first PDU session established at the UE.

Another management entity for wireless communications is described. The management entity may include means for receiving, via a wireless communications link, a first message including a request for a UE to host a first service, where the first message further includes resource record information associated with a domain name of the first service, means for communicating, with a second management entity and in accordance with the resource record information for the domain name, to verify whether the UE is associated with a subscription to host the first service, and means for transmitting, responsive to the first message, a second message that indicates whether the request for the UE to host the first service is accepted, where the first service is associated with a first IP address that corresponds to a first PDU session established at the UE.

A non-transitory computer-readable medium storing code for wireless communications is described. The code may include instructions executable by one or more processors to receive, via a wireless communications link, a first message including a request for a UE to host a first service, where the first message further includes resource record information associated with a domain name of the first service, communicate, with a second management entity and in accordance with the resource record information for the domain name, to verify whether the UE is associated with a subscription to host the first service, and transmit, responsive to the first message, a second message that indicates whether the request for the UE to host the first service is accepted, where the first service is associated with a first IP address that corresponds to a first PDU session established at the UE.

Some examples of the method, management entities, and non-transitory computer-readable medium described herein may further include operations, features, means, or instructions for establishing, via the wireless communications link, the first PDU session, where the first message includes a PDU session establishment request message or includes a PDU session modification request message.

Some examples of the method, management entities, and non-transitory computer-readable medium described herein may further include operations, features, means, or instructions for transmitting, responsive to the PDU session establishment request message or the PDU session modification request message, an indication that the first IP address may be associated with the first service.

Some examples of the method, management entities, and non-transitory computer-readable medium described herein may further include operations, features, means, or instructions for establishing a charging association for the first service in accordance with verifying that the UE may be associated with the subscription to host the first service, where transmitting the second message may be responsive to establishing the charging association.

Some examples of the method, management entities, and non-transitory computer-readable medium described herein may further include operations, features, means, or instructions for establishing a service data flow (SDF), a quality of service (QoS) data flow, or both associated with the first service in accordance with verifying that the UE may be associated with the subscription to host the first service, where transmitting the second message may be responsive to establishing the SDF, the QoS data flow, or both.

Some examples of the method, management entities, and non-transitory computer-readable medium described herein may further include operations, features, means, or instructions for transmitting, to a DNS server associated with the UE and in response to transmitting the second message, a third message including an indication to add the resource record information to the DNS server and receiving, from the DNS server, a message acknowledging that the resource record information may have been added to the DNS server in response to transmitting the third message.

Some examples of the method, management entities, and non-transitory computer-readable medium described herein may further include operations, features, means, or instructions for receiving a fifth message that includes modified resource record information for the domain name of the first service, the modified resource record information associating the domain name of the first service with a second IP address of a second PDU session.

In some examples of the method, management entities, and non-transitory computer-readable medium described herein, the first message includes an indication of a time window associated with an availability of the first service at the UE.

In some examples of the method, management entities, and non-transitory computer-readable medium described herein, the first message includes a second request to host a second service at the UE and includes second resource record information associated with a second domain name of the second service and the second message further indicates whether the second request to host the second service may be accepted.

In some examples of the method, management entities, and non-transitory computer-readable medium described herein, the resource record information includes the first IP address, a port number associated with the first service, a protocol type associated with the first service, a priority value associated with the first service, a weight value associated with the first service, or any combination thereof.

In some examples of the method, management entities, and non-transitory computer-readable medium described herein, the first service includes an application layer service, a web service, a gaming service, a peer-to-peer service, a life broadcast service, an artificial intelligence compute service, or any combination thereof and the first service uses a hyper text transfer protocol, a real-time transport protocol, or a real-time transport control protocol.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports methods for establishing user equipment (UE)-hosted services in accordance with one or more aspects of the present disclosure.

FIG. 2 shows an example of a wireless communications system that supports methods for establishing UE-hosted services in accordance with one or more aspects of the present disclosure.

FIG. 3 shows an example of a process flow that supports methods for establishing UE-hosted services in accordance with one or more aspects of the present disclosure.

FIG. 4 shows an example of a process flow that supports methods for establishing UE-hosted services in accordance with one or more aspects of the present disclosure.

FIG. 5 shows an example of a process flow that supports methods for establishing UE-hosted services in accordance with one or more aspects of the present disclosure.

FIGS. 6 and 7 show block diagrams of devices that support methods for establishing UE-hosted services in accordance with one or more aspects of the present disclosure.

FIG. 8 shows a block diagram of a communications manager that supports methods for establishing UE-hosted services in accordance with one or more aspects of the present disclosure.

FIG. 9 shows a diagram of a system including a device that supports methods for establishing UE-hosted services in accordance with one or more aspects of the present disclosure.

FIGS. 10 and 11 show block diagrams of devices that support methods for establishing UE-hosted services in accordance with one or more aspects of the present disclosure.

FIG. 12 shows a block diagram of a communications manager that supports methods for establishing UE-hosted services in accordance with one or more aspects of the present disclosure.

FIG. 13 shows a diagram of a system including a device that supports methods for establishing UE-hosted services in accordance with one or more aspects of the present disclosure.

FIGS. 14 and 15 show flowcharts illustrating methods that support methods for establishing UE-hosted services in accordance with one or more aspects of the present disclosure.

### DETAILED DESCRIPTION

In some wireless communication systems, a user equipment (UE) may host one or more data services for one or more remote locations (e.g., one or more other UEs, one or more client devices, one or more internet protocol (IP) addresses, one or more IP prefixes, or any combination thereof). Such techniques may enable relatively lower latency and increased content privacy associated with using the services. In some examples, a domain name system (DNS) may be used to resolve an internet protocol (IP) address of such data services (e.g., based on a fully qualified domain name (FQDN) of the service). However, a global DNS may involve a relatively long time to react to IP address changes of UEs and time-dependent service availability, which may cause relatively less availability and flexibility of UE-hosted services. For example, because the UE may move between locations, thereby obtaining different IP addresses for each move, the UE may not obtain a mapping between the different IP addresses and the global DNS in a timely manner, leading to the one or more remote locations being unable to access the service hosted by the UE. Thus, techniques may be desired to enable DNS support for UE hosted data services.

Accordingly, techniques described herein may enable the UE to use a public land mobile network (PLMN) DNS for hosting services in addition to the use of a global DNS. For example, the UE may obtain a FQDN and a PLMN-specific FQDN from a management entity (e.g., one or more entities of a core network (CN)), and the management entity may enter a mapping of the UE-hosted service and the FQDN to a global DNS. The service-hosting UE may obtain an IP address (e.g., select an IP address or receive an IP address from a management entity such as a session management function (SMF)). Accordingly, the management entity may update aspects of the UE-based service (e.g., the IP address of the UE) relatively more dynamically as compared to using the global DNS directly, thereby leading to more flexibility during mobility of the UE.

In some aspects, a service-hosting party may transmit a request to the SMF for the UE to host the service. The SMF may verify the UE and may transmit a response indicating an acceptance or rejection of the request and the IP address or a prefix associated with the IP address for the UE to use to host the service. The UE may accordingly establish the service and exchange one or more messages associated with the service with the one or more remote locations.

Aspects of the disclosure are initially described in the context of wireless communications systems. Aspects of the disclosure are further illustrated by and described herein with reference to process flows, apparatus diagrams, system diagrams, and flowcharts that relate to methods for establishing UE-hosted services.

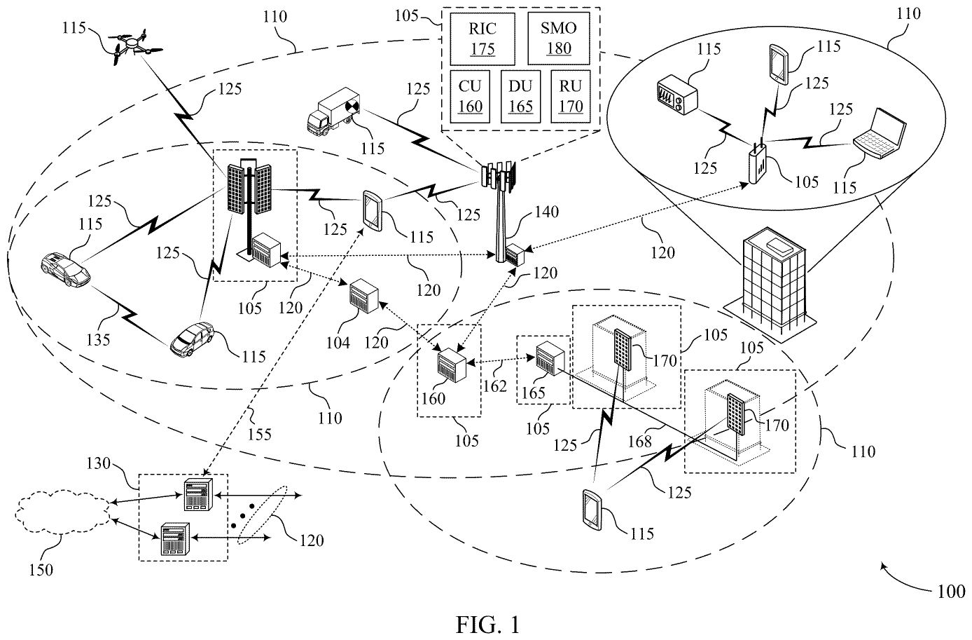

FIG. 1 shows an example of a wireless communications system 100 that supports methods for establishing UE-hosted services in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support methods for establishing UE-hosted services as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{f}) seconds, for which Δƒₘₐₓ may represent a supported subcarrier spacing, and Nf may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023). Each frame may include multiple consecutively-numbered subframes or

slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, IP connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples of the wireless communication system 100, a UE 115 may use a PLMN DNS for hosting services. For example, a service-hosting party may obtain a FQDN and a PLMN-specific FQDN from a management entity (e.g., one or more entities of a CN, such as a RAN, an SMF, a policy control function (PCF), a unified data management (UDM) entity, a UPF, the PLMN, and/or the PLMN DNS), and the management entity may enter a mapping of the UE-hosted service and the FQDN to a global DNS. The service-hosting UE 115 may obtain an IP address (e.g., select an IP address or receive an IP address from a management entity such as the SMF). Accordingly, the management entity may update aspects of the UE-based service (e.g., the IP address of the UE 115) relatively more dynamically as compared to using the global DNS directly.

In some aspects, the UE 115 may transmit a request to the SMF for the UE 115 to host the service. The SMF may verify the UE 115 and may transmit a response indicating an acceptance or rejection of the request and the IP address or a prefix associated with the IP address for the UE 115 to use to host the service. The UE 115 may accordingly establish the service and exchange one or more messages with a client device using the service.

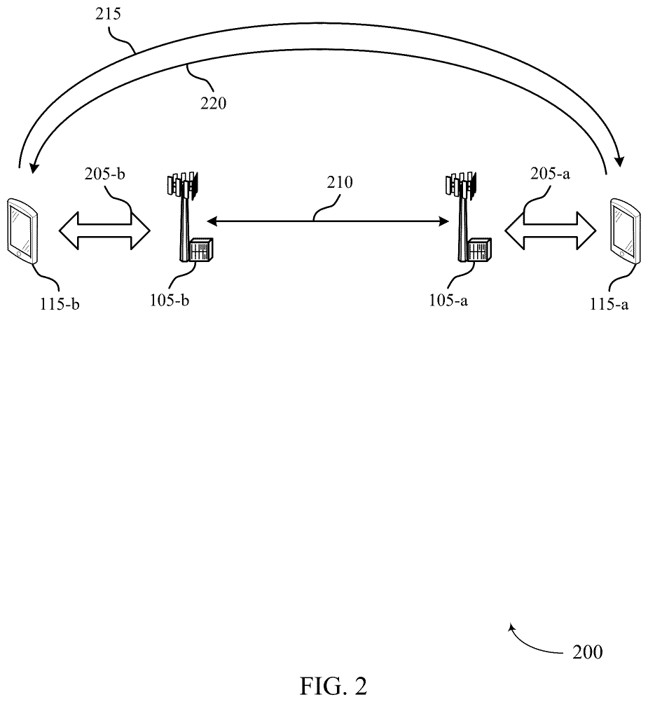

FIG. 2 shows an example of a wireless communications system 200 that supports methods for establishing UE-hosted services in accordance with one or more aspects of the present disclosure. The wireless communications system 200 may implement or may be implemented by aspects of the wireless communications system 100. For example, the wireless communications system 200 may be implemented by one or more UEs 115 (e.g., a UE 115-a, a UE 115-b) or one or more network entities 105 (e.g., a network entity 105-a and a network entity 105-b, which may be representative of one or more management entities of a CN, such as an SMF, UPF, a RAN, a PCF, a UDM entity, or a PLMN), which may be examples of the corresponding devices as described herein with reference to FIG. 1.

In some cases, a UE 115-b (e.g., a client device, a remote location) may use one or more cloud-based services associated with content generated by the cloud or content generated by the UE 115-a (e.g., social networking applications, artificial intelligence computation applications), as well as peer-to-peer applications (e.g., multi-user gaming, IP multimedia subsystem (IMS) applications, remote controlling of devices such as appliances and drones, and the like). The UE 115-b may access the one or more services based on communicating with one or more network entities 105 (e.g., management entities). In some examples, however, hosting a service at a UE 115-a (e.g., rather than a cloud-based service) may take advantage of computational capabilities at UEs 115, which may result in relatively improved (e.g., faster) services as compared to services hosted via the cloud. Additionally, the interface 210 (e.g., 5G air interfaces) may have a relatively high capacity such that end-to-end throughput may not be affected by conditions of the wireless communications system 200.

Additionally, an application service run by a service-hosting UE 115-a may be associated with relatively improved data ownership as compared to cloud-based services. For example, the UE 115-a may host one or more social networking applications, which may enable a user to host data on a device or file owned by the user, which may enable users to retain data ownership. A client device (e.g., the UE 115-b) may discover a location of a service via a DNS. Additionally, or alternatively, the UE 115-a may host a service to support distributed peer-to-peer applications across one or more UEs 115, which may enable multi-user gaming (e.g., with a social group or via massive multi-user online games). Additionally, or alternatively, the UE 115-a may host a live streaming service, which may enable UE-based life broadcasts to groups of users (e.g., for online influencers or video streaming and control feedback for an unmanned ariel vehicle (UAV) or security camera systems.

Additionally, or alternatively, the UE 115-a may host a generative artificial intelligence computation service. For example, a client UE 115-b may offload generative artificial intelligence processing to a host UE 115-a with a relatively higher processing capability, which may enable multiple users to perform distributed processing of generative artificial intelligence applications (e.g., large language models (LLMs)). UE-based generative artificial intelligence applications may use data (e.g., photos, video clips, contact information, notes stored on devices) from one or more peer devices for model training or tuning during workload processing.

Additionally, services hosted by UEs 115 may be deployed relatively faster (e.g., instantly) as compared to cloud-based services as a result of connecting the UE 115-a and the UE 115-b to a same network (e.g., without connecting to a cloud using cloud-based infrastructure, implementation, and deployment). Such UE-based services may use an existing model (e.g., an App Store model) for app development and provisioning. Additionally, for content generated by UEs 115, UE-hosted services may enable delivery by the content generator, which may provide relatively more secure content authenticity and may enable users to retain data ownership (e.g., as compared to a third-party cloud entity). Content privacy for UE-hosted services may be maintained as a result of conducting UE-hosted services within a trusted group of users. In some examples, a mobile network operator (MNO) may create a revenue stream and provide relatively lower latency transport multi-access edge computing (MEC) based on offering data plans including UE-hosted services. For example, the network may provide low latency transport MEC to client devices (e.g., the UE 115-b) connected to a same local UPF as the service-hosting UE 115-a without network-side MEC or edge application servers (EAS).

In some examples, to support internet data services, a service-hosting party (e.g., one or more management entities that may be part of a CN, such as a network entity 105-a and/or a network entity 105-b) may use a DNS to resolve an IP address associated with the service based on a domain name (e.g., an FQDN). That is, a DNS may be mapped to an IP address, such that the DNS may be utilized by one or more remote locations to access the service hosted by the device associated with the IP address. For example, the service-hosting party may obtain an FQDN (e.g., example. com) for the service from a registrar and may provide the IP address of one or more service-hosting instances in turn. The registrar may enter a mapping of the domain name to one or more IP addresses in a global DNS resource record, and may manage the global DNS resource record.

In some examples, a service-hosting UE 115 (e.g., the UE 115-a) may use such DNS techniques to resolve an IP address of the service-hosting UE 115-a based on a domain name of the service. In this way, the client UE 115-b may be agnostic to whether a service is hosted by the UE 115-a or by the network entity 105-a. In some examples, if multiple UEs 115 support a data service, the DNS may direct the client UE 115-b to a UE 115-a (e.g., a topology-wise closest UE 115, such as at a local domain name). If a service-hosting UE 115-a is not available (e.g., due to power constraints or network connectivity constraints), the DNS may provide an alternative IP address (e.g., an IP address of another service-hosting UE 115 or of a network-based instance hosting the service). In examples in which the client UE 115-b uses a local DNS (e.g., provided by MEC framework), the client UE 115-b may discover services hosted by the UEs 115 at a local domain name.

In some examples, however, a global DNS used for cloud-based services may not address one or more issues associated with UE-based service-hosting. For example, the global DNS may not react to dynamic IP address allocation (e.g., if an IP address associated with the UE 115-a changes due to UE mobility). In examples in which the IP address of the service-hosting UE 115-a changes, the global DNS may involve an amount of time (e.g., 1-days) to update the global DNS resource record. In such examples, a PLMN may provide a static IP address to the UE 115-a. However, a static IP address may use a same user plane function (UPF) for multiple locations of the UE 115-a, which may incur a relatively higher routing delay.

Additionally, a global DNS may not react to time-dependent availability of the service-hosting UE 115-a. For example, the UE 115-a may support hosting the service during a time window, and may not support hosting the service outside of the time window. In such examples, the global DNS may not account for time-dependent prioritization between hosting the service at the UE 115-a or at a network entity 105-a (e.g., or another UE 115). In some examples, a management entity may not dynamically provision a local DNS with UE-hosted services as UEs 115 connect with the local NDS. Additionally, an MNO may not charge for UE-based hosting of services running over-the-top (OTT).

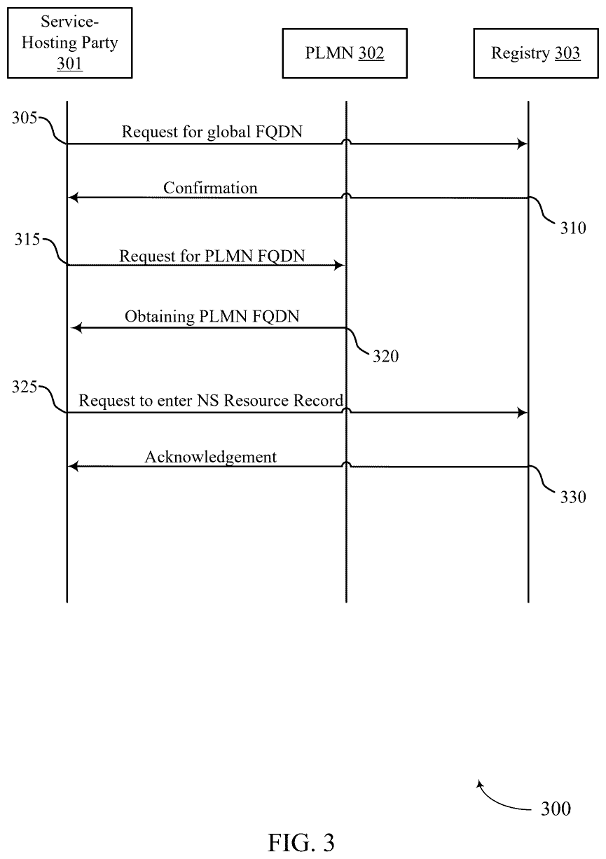

Accordingly, a combination of a relatively slower global DNS and relatively faster PLMN DNS may enable UE-based service-hosting with relatively more flexibility and relatively less latency. For example, a service-hosting party (e.g., a user or set of users associated with a hosting a service) may obtain a domain name (e.g., an FQDN, such as example. com) for the service form a registrar, and may retrieve a PLMN-specific domain name (e.g., a second FQDN such as user-service1.PLMN-name.com). The service-hosting party may request the registrar to enter a mapping of the global domain name to the PLMN-specific domain name (e.g., via CNAME=user-service1.PLMN-name.com) into the global DNS. The UE 115-a may accordingly obtain an IP address for a protocol data unit (PDU) session via a PLMN and may request for the network entity 105-a (e.g., one or more management entities of a CN) to enter a DNS resource record into a DNS of the PLMN for the mapping between the global domain name and the PLMN-specific domain name (e.g., the CNAME). Such techniques are described in further detail with reference to FIG. 3.

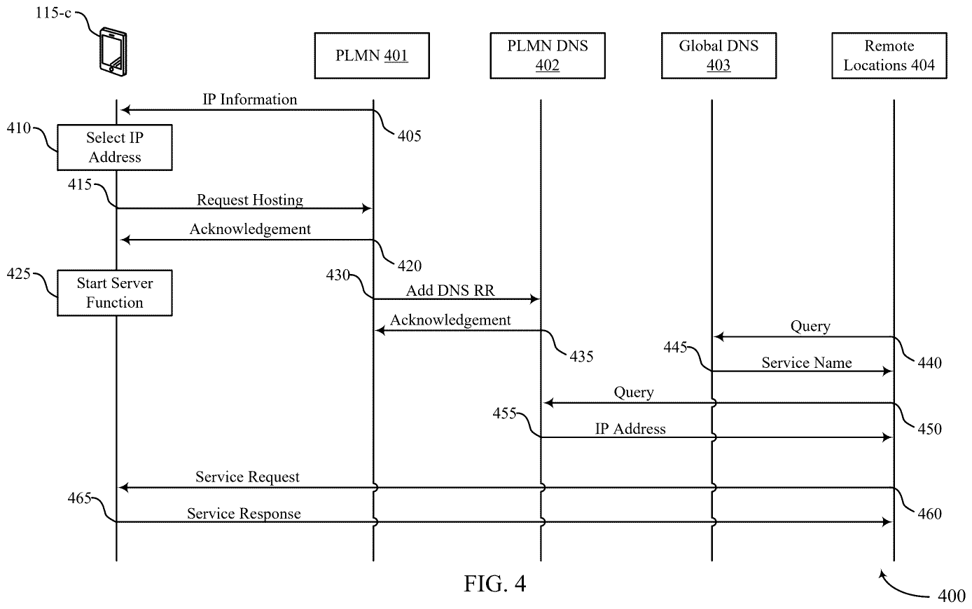

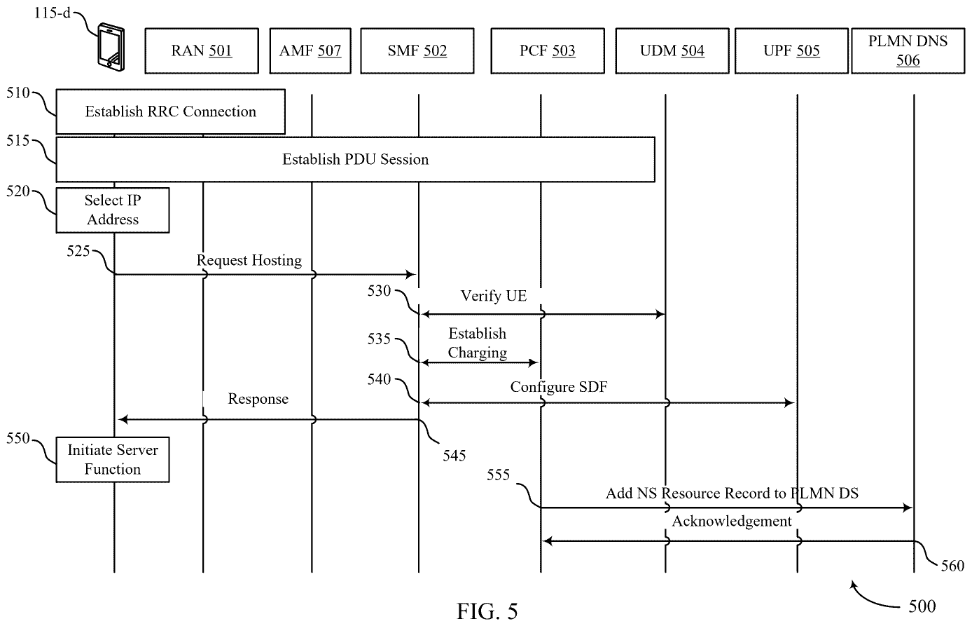

In some examples, the service-hosting UE 115-a may output a hosting request message to a management entity of a CN (e.g., a network entity 105-a via the channel 205). The UE 115-a may receive a response message from the management entity (e.g., via the channel 205) indicating whether the UE 115-a is approved to host the service. Such techniques are described in further detail herein with reference to FIGS. 4 and 5.

A client UE 115-b (e.g., one or more remote locations) may transmit one or more messages 215 associated with the service, which may be similar to (e.g., the same as) communications associated with global DNS service-hosting techniques. For example, the client UE 115-b may output a DNS query for the global domain name example. com to a global DNS and may obtain the PLMN domain name (e.g., user-service1.PLMN-name. com) in return. The client UE 115-b may output a DNS query to the PLMN DNS indicating the PLMN domain name and may obtain the IP address of the service-hosting UE 115-a in return. Accordingly, the client UE 115-b may output a message 215 (e.g., content request) to the service-hosting UE 115-a and may obtain a message 220 (e.g., content deliver) associated with the service from the service-hosting UE 115-a (e.g., via the channel 205-a, the interface 210, and the channel 205-b). Such techniques are described in further detail herein with reference to FIG. 4.

The described techniques may enable UEs 115 to host services with relatively more flexibility and relatively less latency. For example, due to the DNS of the PLMN being of local scope (e.g., under control of the PLMN), the DNS may be updated dynamically as the IP address of the service-hosting UE 115-a changes, and may consider temporal availability and/or connectivity conditions. In examples in which multiple UEs 115 host a same service with different availability time windows, a PLMN DNS may select UEs 115 for client requests associated with the service that are currently available (e.g., within an active time window associated with the selected UE 115).

Additionally, resource record information for the UE-hosted service may be dynamically included in a local DNS of the PLMN for EAS if the service-hosting UE 115-a is connected to the local DNS. In some examples, the PLMN may charge for UE-based service-hosting (e.g., based on additional functionality on the network as compared to network-hosted services).

FIG. 3 shows an example of a process flow 300 that supports methods for establishing UE-hosted services in accordance with one or more aspects of the present disclosure. The process flow 300 may implement or may be implemented by aspects of the wireless communications system 100 or the wireless communications system 200. For example, the process flow 300 may be implemented by a service-hosting party 301 (e.g., one or more users associated with a UE 115 that is to host a service) and one or more network entities 105 (e.g., one or more management entities, such as a PLMN 302 and a registry 303), which may be examples of the corresponding devices as described herein with reference to FIG. 1.

In the following description of the process flow 300, the operations between the service-hosting party 301, the PLMN 302, and the registry 303 may occur in a different order than the example order shown and, in some examples, may be performed by one or more different devices other than those shown as examples. Some operations also may be omitted from the process flow 300, and other operations may be added to the process flow 300. Further, although some operations or signaling may be shown to occur at different times for discussion purposes, these operations may actually occur at the same time.

In some examples, at 305, the service-hosting party 301 may request a global FQDN (e.g., example. com) from a registry 303 (e.g., a registrar) for a data service to be hosted by a UE 115. At 310, the registry 303 may confirm registration of the domain name (e.g., the FQDN) for the service.

At 315, the service-hosting party 301 may request a PLMN FQDN from a PLMN 302 (e.g., from a DNS associated with the PLMN) for the service. That is, the service-hosting party 301 may request, from the PLMN 302, a FQDN within an authoritative zone of the PLMN 302. At 320, the PLMN 302 may provide the PLMN FQDN to the service-hosting party 301 (e.g., user.service1.PLMN.com).

At 325, the service-hosting party 301 may request to enter a name system (NS) resource record associated with the service into the registry 303. For example, the service-hosting party 301 may request to enter a mapping from the global FQDN (e.g., example. com) to the PLMN FQDN (e.g., user.service1.PLMN.com) into the registry 303 (e.g., CNAME =user.service1.PLMN.com). As described herein, a CNAME may be a pointer from a first domain name to a second domain name (e.g., from user.service1.PLMN. com to example. com) and may be a field within the resource record. The UE 115 may accordingly begin hosting the service using the PLMN DNS.

At 330, the registry 303 may output an acknowledgement message to the service-hosting party 301. For example, the acknowledgement message may indicate that the requested mapping has been entered into the registry 303.

FIG. 4 shows an example of a process flow 400 that supports methods for establishing UE-hosted services in accordance with one or more aspects of the present disclosure. The process flow 400 may implement or may be implemented by aspects of the wireless communications system 100, the wireless communications system 200, or the process flow 300. For example, the process flow 400 may be implemented by a UE 115 (e.g., a UE 115-c, which may be a UE 115 hosting a service), one or more remote locations 404 (e.g., client devices, an IP address, an IP prefix, one or more other UEs 115), and one or more network entities 105 (e.g., one or more management entities, such as a PLMN 401, an PLMN DNS 402, and a global DNS 403), which may be examples of the corresponding devices as described herein with reference to FIG. 1.

In the following description of the process flow 400, the operations between the UE 115-c, the remote locations 404, the PLMN 401, the PLMN DNS 402, and the global DNS 403 may occur in a different order than the example order shown and, in some examples, may be performed by one or more different devices other than those shown as examples. Some operations also may be omitted from the process flow 400, and other operations may be added to the process flow 400. Further, although some operations or signaling may be shown to occur at different times for discussion purposes, these operations may actually occur at the same time. Additionally, in some examples, the steps of the process flow 400 may follow the steps of the process flow 300, as described herein with reference to FIG. 3.

In some examples, at 405, the PLMN 401 may indicate information associated with an IP address to the UE 115-c (e.g., an IP address corresponding to a PDU session established at the UE 115-c via which the UE 115-c may host a service at example. com). For example, the PLMN 401 may indicate an IP prefix to the UE 115-c, or may select the IP address for the UE 115-c and may indicate the selected IP address to the UE 115-c. In some examples (e.g., if the PLMN 401 indicates the IP prefix), at 410, the UE 115-c may select the IP address based on the information indicated by the PLMN 401.

At 415, the UE 115-c may output a first message requesting to host the service and indicating resource record information associated with a domain name of the first service (e.g., example.com). For example, the UE 115-c may request for a management entity (e.g., the PLMN 401) to host a DNS resource record for a domain name (e.g., an FQDN) and the IP address in a DNS of the PLMN 401.

At 420, the PLMN may output an acknowledgement message indicating that the PLMN 401 may host the DNS resource record and IP address in the DNS. Accordingly, at 425, the UE 115-c may initiate server function for the service using the IP address.

At 430, the PLMN 401 my add the DNS resource record to the PLMN DNS 402 (e.g., in accordance with the request from the UE 115-c). The PLMN DNS 402 may accordingly host the DNS resource record and IP address. At 435, the PLMN DNS 402 may output an acknowledgement message to the PLMN 401 indicating that the PLMN DNS 402 may host the DNS resource record and IP address.

In some examples, at 440, to use the service and in accordance with the request for the UE 115-c to host the service being accepted, the remote locations 404 (e.g., the client device) may output a DNS query to a global DNS 403 for a PLMN domain name associated with a global domain name (e.g., example.com) associated with the service. At 445, the global DNS may output the PLMN domain name (e.g., CNAME=user. service1.PLMN.com) to the remote locations 404. The global DNS 403 may obtain the PLMN domain name based on the mapping between the PLMN domain name and the global domain name, as described herein with reference to FIG. 3.

At 450, the remote locations 404 may output, to the PLMN DNS 402, a second DNS query for the IP address associated with the service based on the PLMN domain name. At 455, in response to the query, the PLMN DNS 402 may output the IP address based on hosting the DNS resource record and IP address associated with the UE 115-c.

The remote locations 404 may use the service based on obtaining the IP address from the PLMN DNS 402. For example, at 460, based on obtaining the IP address, the remote locations 404 may output, to the UE 115-c, one or more messages associated with the service hosted by the UE 115-c using the IP address. For example, the one or more messages may include an application layer request to the UE-hosted service or a transport layer setup request message to establish a first transport layer between the UE 115-c and the remote locations 404. At 465, the UE 115-c may output a response message (e.g., an application layer service response) to the remote locations 404 based on the request. In some examples, the transport layer protocol setup request message may precede the one or more messages associated with the service.

In some examples, the UE 115-c may update the IP address (e.g., based on a mobility of the UE 115-c). In such examples, the UE 115-c may update the IP address to a second IP address indicated via the first message. In some examples, the second IP address may be indicated to the UE 115-c by the PLMN 401 as part of a PDU session establishment procedure, a PDU session modification procedure, or via another message. To update the IP address, the UE 115-c may output a fifth message indicating modified resource record information for the domain name of the service and the second IP address of a second PDU session. The remote locations 404 may accordingly obtain the second IP address as described herein and may use the service based on transmitting one or more messages to the UE 115-c via the second IP address.

FIG. 5 shows an example of a process flow 500 that supports methods for establishing UE-hosted services in accordance with one or more aspects of the present disclosure. The process flow 500 may implement or may be implemented by aspects of the wireless communications system 100, the wireless communications system 200, the process flow 300, or the process flow 400. For example, the process flow 500 may be implemented by a UE 115 (e.g., a UE 115-d) or one or more network entities 105 (e.g., one or more management entities, such as a RAN 501, an AMF 507, an SMF 502, a PCF 503, a UDM 504, a UPF 505, and a PLMN DNS 506), which may be examples of the corresponding devices as described herein with reference to FIG. 1.

In the following description of the process flow 500, the operations between the UE 115-d, the RAN 501, the SMF 502, the PCF 503, the UDM 504, the UPF 505, the AMF 507, and the PLMN DNS 506 may occur in a different order than the example order shown and, in some examples, may be performed by one or more different devices other than those shown as examples. Some operations also may be omitted from the process flow 500, and other operations may be added to the process flow 500. Further, although some operations or signaling may be shown to occur at different times for discussion purposes, these operations may actually occur at the same time. The techniques described in the context of the process flow 500 may further define the operations of the process flow 400, as described herein with reference to FIG. 4.

At 510, the UE 115-d may establish an RRC connection (e.g., a wireless link) with the RAN 501.

At 515, the UE 115-d may establish a PDU session with the RAN 501, the AMF 507, the SMF 502, a PCF 503, and a UDM 504. In some examples, as part of establishing the PDU session, the UE 115-d may receive IP address information from the SMF 502 for the PDU session via which the UE 115-d may host a first service. In one example, the SMF 502 may indicate an IP prefix for PDU session, such that, at 520, the UE 115-d may select an IP address for the first service. In another example, the SMF 502 may select the IP address for the first service and indicate the selected IP address to the UE 115-d.

Additionally, at 515, if a local DNS (L-DNS) is shared with network EAS, the SMF 502 may include an IP address of the L-DNS in one or more protocol configuration options (PCO) of one or more NAS messages to the UE 115-d, such that the UE 115-d may utilize the L-DNS for communications with one or more remote locations.

As described herein, the first service may be an application layer service, a web service, a gaming service, a peer-to-peer service, a life broadcast service, and/or an artificial intelligence compute service. The service may use a hyper text transfer protocol (HTTP), a real-time transport protocol (RTP), and/or a real-time transport control protocol (RTCP). The UE 115-d may host any quantity of service, and may establish a respective PDU session for each service or may establish a single PDU session for all services.

At 525, the UE 115-d may output, via the wireless communication link, a first message requesting to host the service, where the first message may include resource record information associated with a domain name (e.g., the CNAME=userservice1.PLMN. com) of the first service. For example, the UE 115-c may request hosting of a DNS resource record for the domain name (e.g., an FQDN) of the first service.

In some examples, the first message may be a non-access stratum (NAS) message, such as a packet data unit (PDU) session establishment request or a PDU session modification request message. That is, the UE 115 may communicate the first message during the operations at 515 (e.g., during the PDU session establishment procedure). In such examples, instead of the SMF 502 providing the IP prefix of the PDU session at 515 and the UE 115-d selecting the IP address for the first service at 520, the SMF 502 may select and indicate a dedicated IP address for each service to be hosted by the UE 115-d. In this way, the UE 115-d may receive the IP address for the first service from the SMF 502 and refrain from performing the operations at 520. Further, in such examples (e.g., if the SMF 502 selects the IP address for the service), the UE 115-d may not indicate the IP address of the service to the SMF 502.

In some other examples, if, at 515, the UE 115-d receives the IP prefix for the PDU session and, at 520, selects the IP address for the first service, the UE 115-d may transmit, via the first message, an indication of the selected IP address to the SMF 502 as part of the resource record information.

In some examples, if, at 515, the UE 115-d receives the IP address of the L-DNS, the UE 115-d may indicate, via the first message, the IP address of the L-DNS, a request to host the resource record information on the L-DNS server, or both. That is, if the UE 115-d obtains information for the L-DNS server for EAS services at 515, the UE 115-d may include an indication, into the first message (e.g., the NAS request for DNS resource record hosting), whether the resource record information for the service is to be hosted on the server of the L-DNS. In such examples, the first message may include the IP address of the server of the L-DNS.

The resource record information may include the IP address associated with the first service, a port number associated with the first service, a protocol type associated with the first service, a priority value associated with the first service, and/or a weight value associated with the first service. In some examples, the resource record information may include equivalent information (e.g., IP address, port number, protocol type, priority value, weight value) associated with one or more other instances of the UE 115-d supporting the service.

In some examples, the UE 115-d may indicate, via the first message, one or more differentiated values for the priority and the weight associated with the service based one or more conditions of the UE 115-d. For example, the UE 115-d may indicate different priority or weight values based on whether the UE 115-d is roaming, is not reachable, based on one or more RRC states of the UE 115-d (e.g., connected, idle, inactive), a tracking area in which the UE 115-d is residing, a cell the UE 115-d is connected on, and the like.

As an illustrative example, the UE 115-d may provide a first IP address associated with the service and a second IP address associated with the service. The UE 115-d may provide respective first priority values associated with each of the first IP address and the second IP address for first conditions of the UE 115-d (e.g., for examples in which the UE 115-d is in an RRC connected state), and respective second priority values associated with each of the first IP address and the second IP address for second conditions of the UE 115-d (e.g., for examples in which the UE 115-d is in an RRC idle state). Accordingly, the UE 115-d may indicate that the first IP address has a higher priority in the RRC connected state, and the second IP address has a higher priority in the RRC idle state. In some examples, the UE 115-d may transmit one or more messages updating the conditions of the UE 115-d and/or updating the differentiated values of the weight and priority.

In some examples, the first message may indicate one or more time windows (e.g., durations) during which the service may be available. The UE 115-d may accordingly receive and respond to service requests during the time windows (e.g., and may not receive and respond to service requests outside of the time windows). In some examples, the first message may indicate a second request to host a second service at the UE 115-d. In such examples, the first message may include second resource record information associated with a second domain name of the second service. That is, the first message may include a list indicating multiple sets of resource record information each for a respective service. In some other examples, at 525, the UE 115-d may transmit respective first messages for each service hosted at the UE 115-d.

At 530, the SMF 502 may communicate with one or more additional management entities to determine whether the UE 115-d may host the service (e.g., based on receiving the first message indicating the request). For example, at 530, the SMF 502 may perform a verification of the UE 115-d (e.g., based on communicating with the UDM 504 to confirm whether the UE 115-d is authorized to host the service based on the resource record information). That is, the SMF 502 may verify whether the UE 115-d has a subscription for a UE-hosted service with the PLMN FQDN. The UDM 504 may store the PLMN FQDN for the service in a subscription record associated with the UE 115-d.

At 535, the SMF 502 may establish (e.g., configure, create) a charging association for the UE-hosted service (e.g., based on communicating with the PCF 503). For example, the SMF 502 may establish a method via which the PLMN may charge the UE 115-d for hosting the service. At 540, the SMF 502 may establish (e.g., configure, create) a service data flow (SDF) and/or a quality of service (QoS) SDF for traffic related to the UE-hosted service (e.g., based on communicating with the UPF 505).

At 545, the SMF 502 may output a second message (e.g., an acknowledgement message, a second NAS message) indicating that the PLMN 401 may host the DNS resource record and IP address in the DNS. That is, the second message may indicate whether the request to host the service is accepted (e.g., granted) or rejected. The SMF 502 may output the second message in response to verifying the UE 115-d, in response to establishing the charging session, and/or in response to establishing the SDF and/or the QoS SDF.

In some examples (e.g., if the first message indicates the second request for the UE 115-d to host the second service), the second message may additionally indicate an acceptance or rejection of the request for the UE 115-d to host the second service. That is, the second message may indicate a differentiated list of acceptances or rejections associated with each service requested by the UE 115-d.

At 550, in examples in which the second message indicates that the request is accepted, the UE 115-d may initiate server function for the service at the selected IP address (e.g., based on the port number and other information provided in the first message). The UE 115-d may accordingly handle client requests associated with the service, as described herein with reference to FIG. 4. That is, based on authorization of the DNS information hosting for a service, the UE 115-d may initiate a server function using the corresponding IP address, and potentially port number and other information that is provided in the first message at 525 and may begin to handle requests from one or more locations. A remote location may correspond to an IP address, an IP prefix, a client device, and/or one or more other UEs, among other examples.

At 555, the SMF 502 may output the NS resource record to the PLMN DNS 506 (e.g., to add the NS resource record to the PLMN DNS 506). That is, in response to confirming that the UE 115-d is authorized to host the service, the SMF 502 may provision a DNS server of the PLMN with a DNS resource record containing the information (e.g., the resource record information) provided by the UE 115-d.

In some examples, if the UE 115-d requests, at 525, to host the resource record information in the L-DNS, the SMF 502 may include the resource record in the L-DNS for EAS (e.g., if indicated by the UE 115-d). In examples in which the IP address of the UE 115-d is non-public (e.g., if the UPF 505 is behind and/or applies a network address translation (NAT) function), a CN function may enter a corresponding public IP address into the DNS resource record.

At 560, the PLMN DNS 506 may output an acknowledgement message to the SMF 502 indicating that the PLMN DNS 506 will add the NS resource record.

A client device may use the service based on obtaining the IP address from the PLMN DNS 506. For example, the client device may output, to the UE 115-d, one or more messages associated with the service hosted by the UE 115-d using the IP address, as described herein with reference to FIG. 4. In some examples, the UE 115-d may receive the one or more messages during the one or more time windows. The UE 115-d may output a response to the one or more messages based on the one or more messages being received within the one or more time windows. In some examples, the SMF 502 may add, remove, activate, and/or deactivate the resource records associated with each service at the UE 115-d in the DNS of the PLMN based on the indicated time windows.

In some examples, the UE 115-d may update the IP address (e.g., based on a mobility of the UE 115-d, such as based on moving to an area with a different UPF 505). In such examples, the UE 115-d may update the IP address to a second IP address. Additionally, or alternatively, the UE 115-d may obtain a new PDU session associated with the second IP address and receive a NAS indication (e.g., from the SMF 502) for the hosting of the DNS resource record and the second IP address. For example, the UE 115-d may obtain the IP address proactively by receiving the second IP address from the SMF 502 as part of a PDU session establishment procedure or a PDU session modification procedure, a PDU session modification procedure, or via another message. Additionally, or alternatively, the UE 115-d may select the second IP address from a second IP prefix obtained from the SMF 502 for the new PDU session.

To update the IP address, the UE 115-d may output a fifth message indicating modified resource record information for the domain name of the service and the second IP address. The remote devices may accordingly obtain the second IP address as described herein and may use the service based on transmitting one or more messages to the UE 115-d via the second IP address.

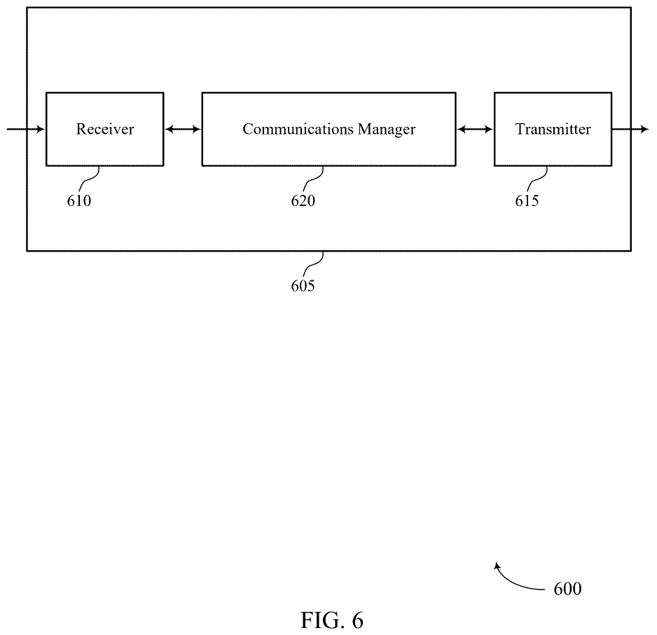

FIG. 6 shows a block diagram 600 of a device 605 that supports methods for establishing UE-hosted services in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to methods for establishing UE-hosted services). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to methods for establishing UE-hosted services). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of methods for establishing UE-hosted services as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting, via a wireless communications link, a first message including a request for the UE to host a first service, where the first message further includes resource record information associated with a domain name of the first service. The communications manager 620 is capable of, configured to, or operable to support a means for receiving, responsive to the first message, a second message that indicates whether the request for the UE to host the first service is accepted. The communications manager 620 is capable of, configured to, or operable to support a means for receiving, in accordance with the request being accepted and via a first IP address that corresponds to a first PDU session established at the UE, a third message from a client device that is associated with the first service hosted at the UE. The communications manager 620 is capable of, configured to, or operable to support a means for transmitting, responsive to the third message and via the first IP address, a fourth message associated with the first service to the client device.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for a UE to host a service using a PLMN DNS, which may enable more efficient utilization of communication resources.

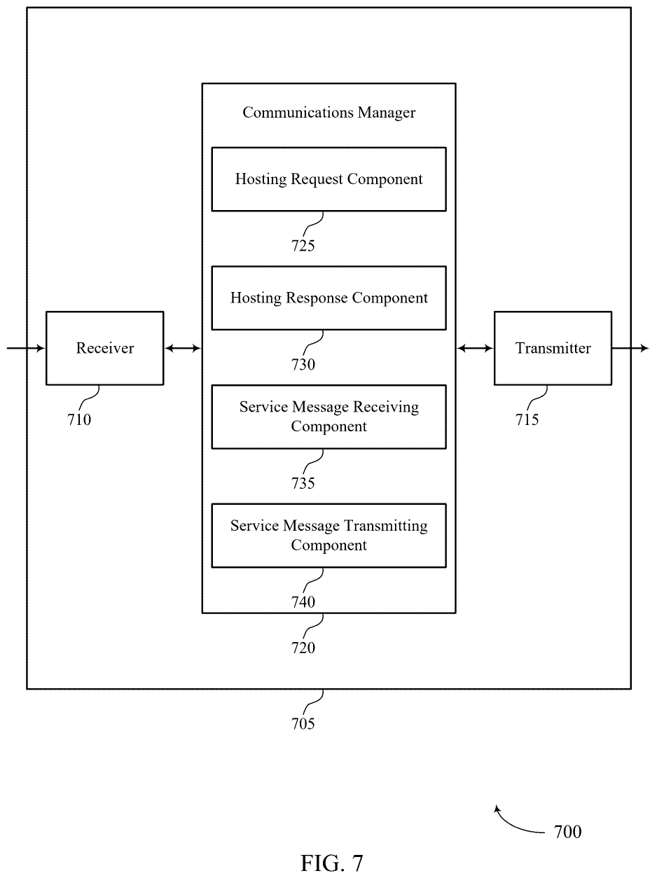

FIG. 7 shows a block diagram 700 of a device 705 that supports methods for establishing UE-hosted services in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to methods for establishing UE-hosted services). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to methods for establishing UE-hosted services). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of methods for establishing UE-hosted services as described herein. For example, the communications manager 720 may include a hosting request component 725, a hosting response component 730, a service message receiving component 735, a service message transmitting component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The hosting request component 725 is capable of, configured to, or operable to support a means for transmitting, via a wireless communications link, a first message including a request for the UE to host a first service, where the first message further includes resource record information associated with a domain name of the first service. The hosting response component 730 is capable of, configured to, or operable to support a means for receiving, responsive to the first message, a second message that indicates whether the request for the UE to host the first service is accepted. The service message receiving component 735 is capable of, configured to, or operable to support a means for receiving, in accordance with the request being accepted and via a first IP address that corresponds to a first PDU session established at the UE, a third message from a client device that is associated with the first service hosted at the UE. The service message transmitting component 740 is capable of, configured to, or operable to support a means for transmitting, responsive to the third message and via the first IP address, a fourth message associated with the first service to the client device.

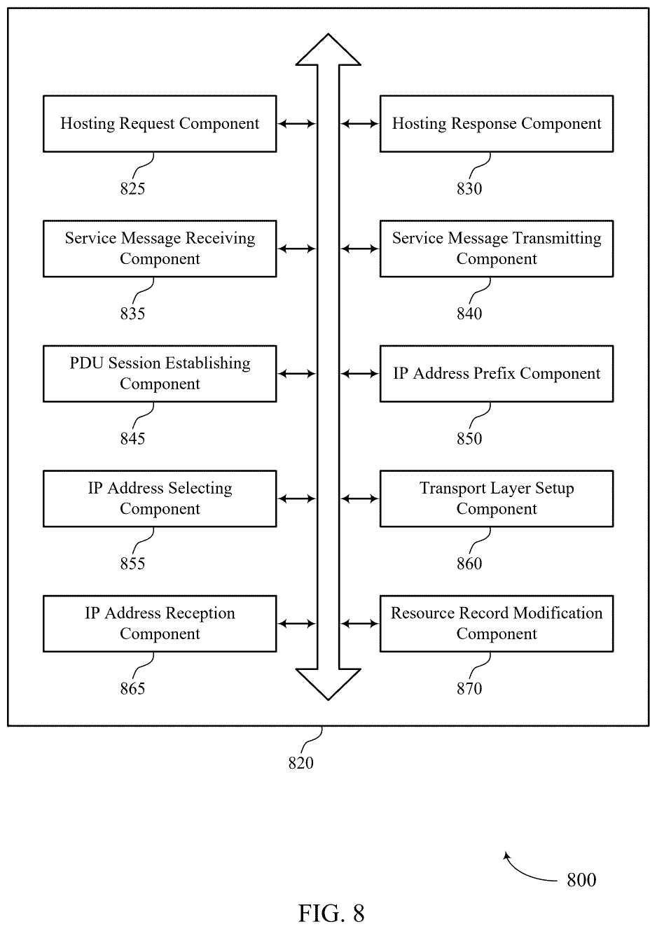

FIG. 8 shows a block diagram 800 of a communications manager 820 that supports methods for establishing UE-hosted services in accordance with one or more aspects of the present disclosure. The communications manager 820 may be an example of aspects of a communications manager 620, a communications manager 720, or both, as described herein. The communications manager 820, or various components thereof, may be an example of means for performing various aspects of methods for establishing UE-hosted services as described herein. For example, the communications manager 820 may include a hosting request component 825, a hosting response component 830, a service message receiving component 835, a service message transmitting component 840, a PDU session establishing component 845, an IP address prefix component 850, an IP address selecting component 855, a transport layer setup component 860, an IP address reception component 865, a resource record modification component 870, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The hosting request component 825 is capable of, configured to, or operable to support a means for transmitting, via a wireless communications link, a first message including a request for the UE to host a first service, where the first message further includes resource record information associated with a domain name of the first service. The hosting response component 830 is capable of, configured to, or operable to support a means for receiving, responsive to the first message, a second message that indicates whether the request for the UE to host the first service is accepted. The service message receiving component 835 is capable of, configured to, or operable to support a means for receiving, in accordance with the request being accepted and via a first IP address that corresponds to a first PDU session established at the UE, a third message from a client device that is associated with the first service hosted at the UE. The service message transmitting component 840 is capable of, configured to, or operable to support a means for transmitting, responsive to the third message and via the first IP address, a fourth message associated with the first service to the client device.

In some examples, the PDU session establishing component 845 is capable of, configured to, or operable to support a means for establishing, via the wireless communications link, the first PDU session, where the first message includes a PDU session establishment request message or includes a PDU session modification request message.

In some examples, the IP address reception component 865 is capable of, configured to, or operable to support a means for receiving, responsive to the PDU session establishment request message or the PDU session modification request message, an indication that the first IP address is associated with the first service.

In some examples, the IP address prefix component 850 is capable of, configured to, or operable to support a means for receiving, as part of a PDU session establishment procedure or a PDU session modification procedure, a prefix for an IP address associated with the first PDU session. In some examples, the IP address selecting component 855 is capable of, configured to, or operable to support a means for selecting the first IP address for the first service according to the prefix for the IP address, where the resource record information includes the first IP address associated with the first service.

In some examples, to support receiving the third message, the transport layer setup component 860 is capable of, configured to, or operable to support a means for receiving, from the client device, a transport layer setup request message to establish a first transport layer between the client device and the UE.

In some examples, the IP address reception component 865 is capable of, configured to, or operable to support a means for receiving, as part of a PDU session establishment procedure or a PDU session modification procedure for the first PDU session, an indication of a second IP address of a local domain name system server, where the first message includes a second request for the resource record information to be hosted at the local domain name system server, and where the first message includes an indication of the second IP address.

In some examples, the resource record modification component 870 is capable of, configured to, or operable to support a means for transmitting a fifth message that includes modified resource record information for the domain name of the first service, the modified resource record information associating the domain name of the first service with a second IP address of a second PDU session. In some examples, the service message receiving component 835 is capable of, configured to, or operable to support a means for receiving, via the second IP address, a sixth message from the client device that is associated with the first service hosted at the UE.

In some examples, transmitting the fifth message is in response to a mobility of the UE.

In some examples, the first message includes an indication of a time window associated with an availability of the first service at the UE. In some examples, transmitting the fourth message is in response to the third message being received within the time window.

In some examples, the first message includes a second request to host a second service at the UE and includes second resource record information associated with a second domain name of the second service. In some examples, the second message further indicates whether the second request to host the second service is accepted.

In some examples, the resource record information includes the first IP address, a port number associated with the first service, a protocol type associated with the first service, a priority value associated with the first service, a weight value associated with the first service, or any combination thereof.

In some examples, the first service includes an application layer service, a web service, a gaming service, a peer-to-peer service, a life broadcast service, an artificial intelligence compute service, or any combination thereof. In some examples, the first service uses a HTTP, a RTP, or a RTCP.

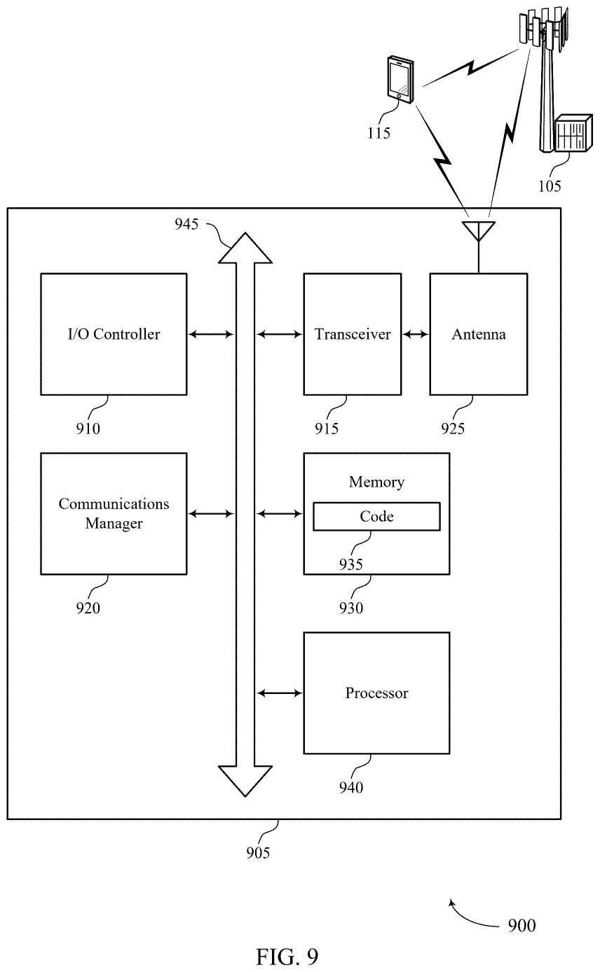

FIG. 9 shows a diagram of a system 900 including a device 905 that supports methods for establishing UE-hosted services in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting methods for establishing UE-hosted services). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting, via a wireless communications link, a first message including a request for the UE to host a first service, where the first message further includes resource record information associated with a domain name of the first service. The communications manager 920 is capable of, configured to, or operable to support a means for receiving, responsive to the first message, a second message that indicates whether the request for the UE to host the first service is accepted. The communications manager 920 is capable of, configured to, or operable to support a means for receiving, in accordance with the request being accepted and via a first IP address that corresponds to a first PDU session established at the UE, a third message from a client device that is associated with the first service hosted at the UE. The communications manager 920 is capable of, configured to, or operable to support a means for transmitting, responsive to the third message and via the first IP address, a fourth message associated with the first service to the client device.

By including or configuring the communications manager 920 in accordance with examples as described herein, the device 905 may support techniques for a UE to host a service using a PLMN DNS, which may enable reduced latency and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described herein with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of methods for establishing UE-hosted services as described herein, or the at least one processor 940 and the at least one memory 930 may be otherwise configured to, individually or collectively, perform or support such operations.

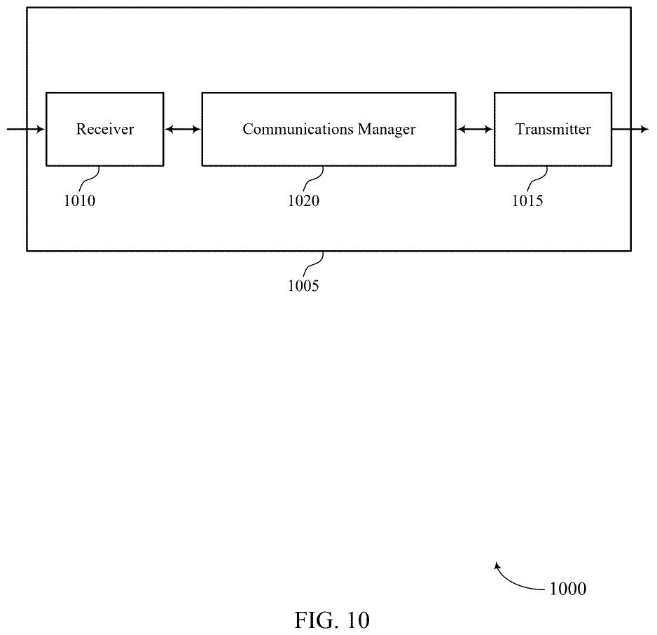

FIG. 10 shows a block diagram 1000 of a device 1005 that supports methods for establishing UE-hosted services in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of methods for establishing UE-hosted services as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for receiving, via a wireless communications link, a first message including a request for a UE to host a first service, where the first message further includes resource record information associated with a domain name of the first service. The communications manager 1020 is capable of, configured to, or operable to support a means for communicating, with a second management entity and in accordance with the resource record information for the domain name, to verify whether the UE is associated with a subscription to host the first service. The communications manager 1020 is capable of, configured to, or operable to support a means for transmitting, responsive to the first message, a second message that indicates whether the request for the UE to host the first service is accepted, where the first service is associated with a first IP address that corresponds to a first PDU session established at the UE.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for a UE to host a service using a PLMN DNS, which may enable more efficient utilization of communication resources.

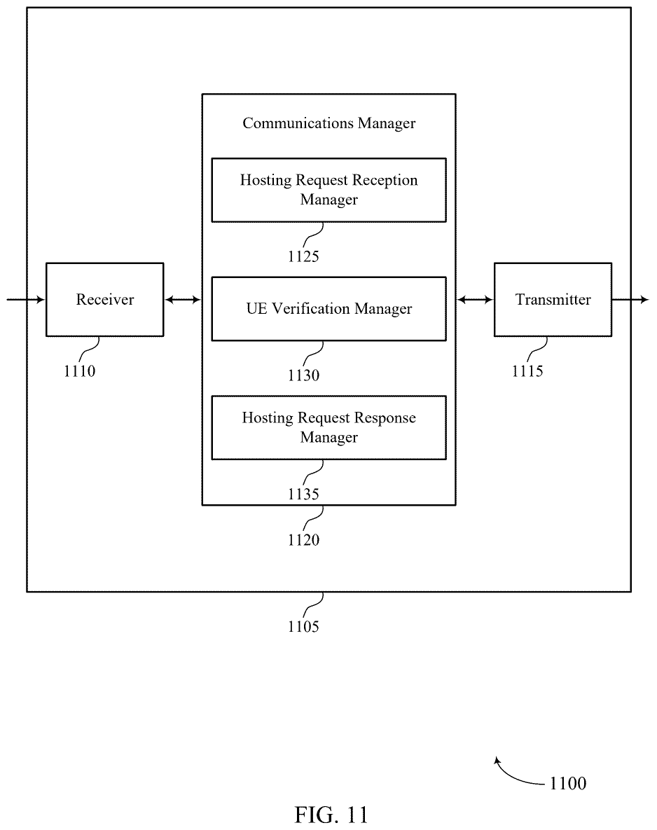

FIG. 11 shows a block diagram 1100 of a device 1105 that supports methods for establishing UE-hosted services in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, PDUs, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, PDUs, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of methods for establishing UE-hosted services as described herein. For example, the communications manager 1120 may include a hosting request reception manager 1125, a UE verification manager 1130, a hosting request response manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The hosting request reception manager 1125 is capable of, configured to, or operable to support a means for receiving, via a wireless communications link, a first message including a request for a UE to host a first service, where the first message further includes resource record information associated with a domain name of the first service. The UE verification manager 1130 is capable of, configured to, or operable to support a means for communicating, with a second management entity and in accordance with the resource record information for the domain name, to verify whether the UE is associated with a subscription to host the first service. The hosting request response manager 1135 is capable of, configured to, or operable to support a means for transmitting, responsive to the first message, a second message that indicates whether the request for the UE to host the first service is accepted, where the first service is associated with a first IP address that corresponds to a first PDU session established at the UE.

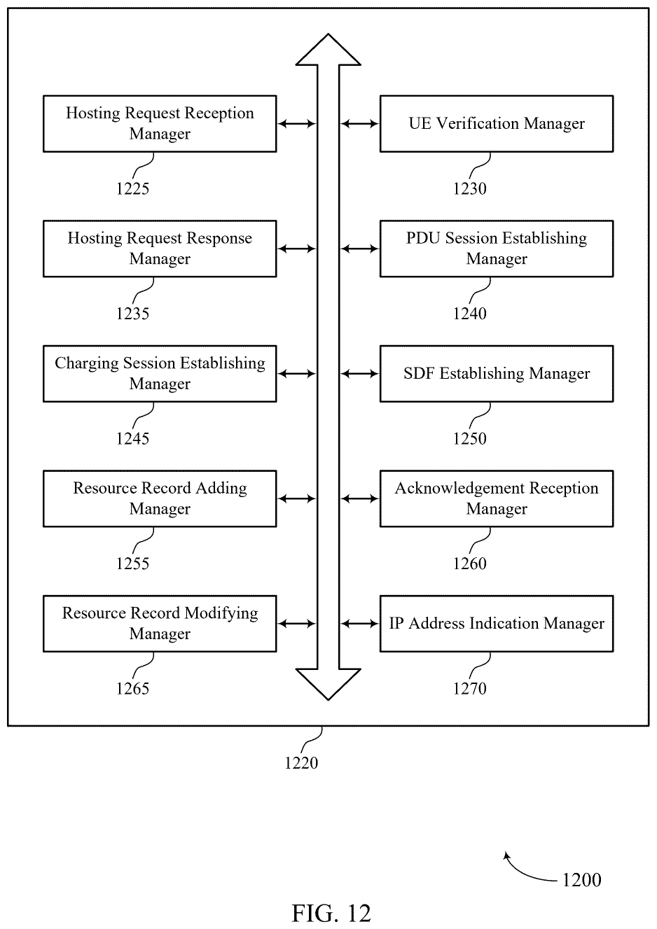

FIG. 12 shows a block diagram 1200 of a communications manager 1220 that supports methods for establishing UE-hosted services in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of methods for establishing UE-hosted services as described herein. For example, the communications manager 1220 may include a hosting request reception manager 1225, a UE verification manager 1230, a hosting request response manager 1235, a PDU session establishing manager 1240, a charging session establishing manager 1245, an SDF establishing manager 1250, a resource record adding manager 1255, an acknowledgement reception manager 1260, a resource record modifying manager 1265, an IP address indication manager 1270, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The hosting request reception manager 1225 is capable of, configured to, or operable to support a means for receiving, via a wireless communications link, a first message including a request for a UE to host a first service, where the first message further includes resource record information associated with a domain name of the first service. The UE verification manager 1230 is capable of, configured to, or operable to support a means for communicating, with a second management entity and in accordance with the resource record information for the domain name, to verify whether the UE is associated with a subscription to host the first service. The hosting request response manager 1235 is capable of, configured to, or operable to support a means for transmitting, responsive to the first message, a second message that indicates whether the request for the UE to host the first service is accepted, where the first service is associated with a first IP address that corresponds to a first PDU session established at the UE.

In some examples, the PDU session establishing manager 1240 is capable of, configured to, or operable to support a means for establishing, via the wireless communications link, the first PDU session, where the first message includes a PDU session establishment request message or includes a PDU session modification request message.

In some examples, the IP address indication manager 1270 is capable of, configured to, or operable to support a means for transmitting, responsive to the PDU session establishment request message or the PDU session modification request message, an indication that the first IP address is associated with the first service.

In some examples, the charging session establishing manager 1245 is capable of, configured to, or operable to support a means for establishing a charging association for the first service in accordance with verifying that the UE is associated with the subscription to host the first service, where transmitting the second message is responsive to establishing the charging association.

In some examples, the SDF establishing manager 1250 is capable of, configured to, or operable to support a means for establishing a SDF, a QoS data flow, or both associated with the first service in accordance with verifying that the UE is associated with the subscription to host the first service, where transmitting the second message is responsive to establishing the SDF, the QoS data flow, or both.

In some examples, the resource record adding manager 1255 is capable of, configured to, or operable to support a means for transmitting, to a DNS server associated with the UE and in response to transmitting the second message, a third message including an indication to add the resource record information to the DNS server. In some examples, the acknowledgement reception manager 1260 is capable of, configured to, or operable to support a means for receiving, from the DNS server, a message acknowledging that the resource record information has been added to the DNS server in response to transmitting the third message.

In some examples, the resource record modifying manager 1265 is capable of, configured to, or operable to support a means for receiving a fifth message that includes modified resource record information for the domain name of the first service, the modified resource record information associating the domain name of the first service with a second IP address of a second PDU session.

In some examples, the first message includes an indication of a time window associated with an availability of the first service at the UE.

In some examples, the first message includes a second request to host a second service at the UE and includes second resource record information associated with a second domain name of the second service. In some examples, the second message further indicates whether the second request to host the second service is accepted.

In some examples, the resource record information includes the first IP address, a port number associated with the first service, a protocol type associated with the first service, a priority value associated with the first service, a weight value associated with the first service, or any combination thereof.

In some examples, the first service includes an application layer service, a web service, a gaming service, a peer-to-peer service, a life broadcast service, an artificial intelligence compute service, or any combination thereof. In some examples, the first service uses a HTTP, a RTP, or a RTCP.

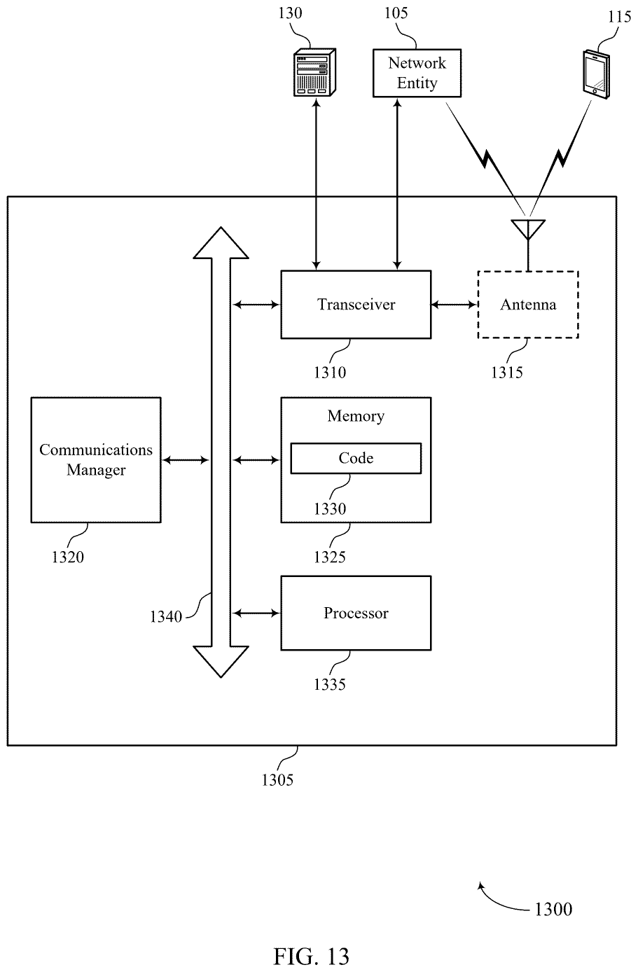

FIG. 13 shows a diagram of a system 1300 including a device 1305 that supports methods for establishing UE-hosted services in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting methods for establishing UE-hosted services). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for receiving, via a wireless communications link, a first message including a request for a UE to host a first service, where the first message further includes resource record information associated with a domain name of the first service. The communications manager 1320 is capable of, configured to, or operable to support a means for communicating, with a second management entity and in accordance with the resource record information for the domain name, to verify whether the UE is associated with a subscription to host the first service. The communications manager 1320 is capable of, configured to, or operable to support a means for transmitting, responsive to the first message, a second message that indicates whether the request for the UE to host the first service is accepted, where the first service is associated with a first IP address that corresponds to a first PDU session established at the UE.

By including or configuring the communications manager 1320 in accordance with examples as described herein, the device 1305 may support techniques for a UE to host a service using a PLMN DNS, which may enable reduced latency and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described herein with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of methods for establishing UE-hosted services as described herein, or the at least one processor 1335 and the at least one memory 1325 may be otherwise configured to, individually or collectively, perform or support such operations.

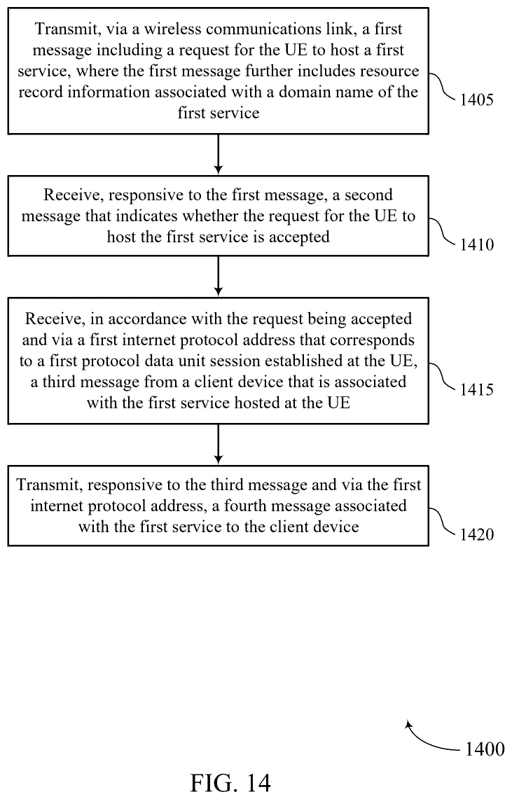

FIG. 14 shows a flowchart illustrating a method 1400 that supports methods for establishing UE-hosted services in accordance with one or more aspects of the present disclosure. The operations of the method 1400 may be implemented by a UE or its components as described herein. For example, the operations of the method 1400 may be performed by a UE 115 as described herein with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting, via a wireless communications link, a first message including a request for the UE to host a first service, where the first message further includes resource record information associated with a domain name of the first service. The operations of 1405 may be performed in accordance with examples as disclosed herein. In some examples, aspects of the operations of 1405 may be performed by a hosting request component 825 as described herein with reference to FIG. 8.

At 1410, the method may include receiving, responsive to the first message, a second message that indicates whether the request for the UE to host the first service is accepted. The operations of 1410 may be performed in accordance with examples as disclosed herein. In some examples, aspects of the operations of 1410 may be performed by a hosting response component 830 as described herein with reference to FIG. 8.

At 1415, the method may include receiving, in accordance with the request being accepted and via a first IP address that corresponds to a first PDU session established at the UE, a third message from a client device that is associated with the first service hosted at the UE. The operations of 1415 may be performed in accordance with examples as disclosed herein. In some examples, aspects of the operations of 1415 may be performed by a service message receiving component 835 as described herein with reference to FIG. 8.

At 1420, the method may include transmitting, responsive to the third message and via the first IP address, a fourth message associated with the first service to the client device. The operations of 1420 may be performed in accordance with examples as disclosed herein. In some examples, aspects of the operations of 1420 may be performed by a service message transmitting component 840 as described herein with reference to FIG. 8.

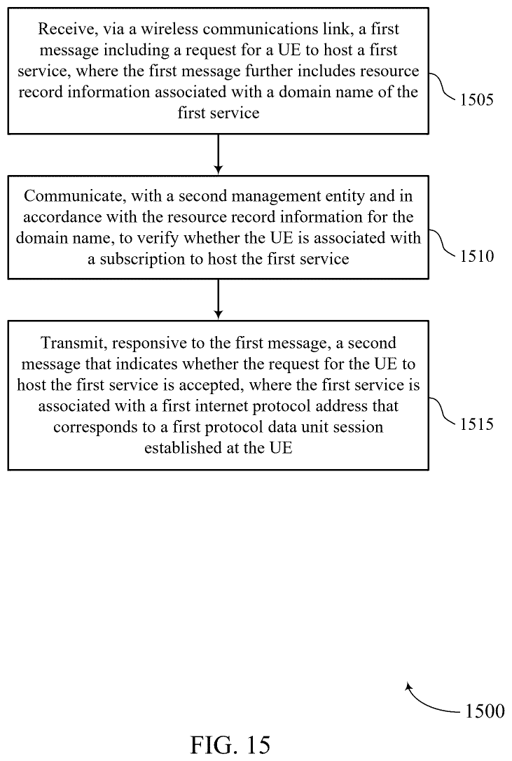

FIG. 15 shows a flowchart illustrating a method 1500 that supports methods for establishing UE-hosted services in accordance with one or more aspects of the present disclosure. The operations of the method 1500 may be implemented by a network entity or its components as described herein. For example, the operations of the method 1500 may be performed by a network entity as described herein with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include receiving, via a wireless communications link, a first message including a request for a UE to host a first service, where the first message further includes resource record information associated with a domain name of the first service. The operations of 1505 may be performed in accordance with examples as disclosed herein. In some examples, aspects of the operations of 1505 may be performed by a hosting request reception manager 1225 as described herein with reference to FIG. 12.

At 1510, the method may include communicating, with a second management entity and in accordance with the resource record information for the domain name, to verify whether the UE is associated with a subscription to host the first service. The operations of 1510 may be performed in accordance with examples as disclosed herein. In some examples, aspects of the operations of 1510 may be performed by a UE verification manager 1230 as described herein with reference to FIG. 12.

At 1515, the method may include transmitting, responsive to the first message, a second message that indicates whether the request for the UE to host the first service is accepted, where the first service is associated with a first IP address that corresponds to a first PDU session established at the UE. The operations of 1515 may be performed in accordance with examples as disclosed herein. In some examples, aspects of the operations of 1515 may be performed by a hosting request response manager 1235 as described herein with reference to FIG. 12.

The following provides an overview of aspects of the present disclosure:

Aspect 1: A method for wireless communications by a UE, comprising: transmitting, via a wireless communications link, a first message comprising a request for the UE to host a first service, wherein the first message further comprises resource record information associated with a domain name of the first service; receiving, responsive to the first message, a second message that indicates whether the request for the UE to host the first service is accepted; receiving, in accordance with the request being accepted and via a first IP address that corresponds to a first PDU session established at the UE, a third message from a client device that is associated with the first service hosted at the UE; and transmitting, responsive to the third message and via the first IP address, a fourth message associated with the first service to the client device.

Aspect 2: The method of aspect 1, further comprising: establishing, via the wireless communications link, the first PDU session, wherein the first message comprises a PDU session establishment request message or comprises a PDU session modification request message.

Aspect 3: The method of aspect 2, further comprising: receiving, responsive to the PDU session establishment request message or the PDU session modification request message, an indication that the first IP address is associated with the first service.

Aspect 4: The method of any of aspects 1 through 3, further comprising: receiving, as part of a PDU session establishment procedure, a prefix for an IP address associated with the first PDU session; and selecting the first IP address for the first service according to the prefix for the IP address, wherein the resource record information comprises the first IP address associated with the first service.

Aspect 5: The method of any of aspects 1 through 4, wherein receiving the third message further comprises: receiving, from the client device, a transport layer setup request message to establish a first transport layer between the client device and the UE.

Aspect 6: The method of any of aspects 1 through 5, further comprising: receiving, as part of a PDU session establishment procedure or a PDU session modification procedure for the first PDU session, an indication of a second IP address of a local DNS server, wherein the first message comprises a second request for the resource record information to be hosted at the local DNS server, and wherein the first message comprises an indication of the second IP address.

Aspect 7: The method of any of aspects 1 through 6, further comprising: transmitting a fifth message that comprises modified resource record information for the domain name of the first service, the modified resource record information associating the domain name of the first service with a second IP address of a second PDU session; and receiving, via the second IP address, a sixth message from the client device that is associated with the first service hosted at the UE.

Aspect 8: The method of aspect 7, wherein transmitting the fifth message is in response to a mobility of the UE.

Aspect 9: The method of any of aspects 1 through 8, wherein the first message comprises an indication of a time window associated with an availability of the first service at the UE, transmitting the fourth message is in response to the third message being received within the time window.

Aspect 10: The method of any of aspects 1 through 9, wherein the first message comprises a second request to host a second service at the UE and comprises second resource record information associated with a second domain name of the second service, and the second message further indicates whether the second request to host the second service is accepted.

Aspect 11: The method of any of aspects 1 through 10, wherein the resource record information comprises the first IP address, a port number associated with the first service, a protocol type associated with the first service, a priority value associated with the first service, a weight value associated with the first service, or any combination thereof.

Aspect 12: The method of any of aspects 1 through 11, wherein the first service comprises an application layer service, a web service, a gaming service, a peer-to-peer service, a life broadcast service, an artificial intelligence compute service, or any combination thereof, and the first service uses a hyper text transfer protocol, a real-time transport protocol, or a real-time transport control protocol.

Aspect 13: A method for wireless communications by a management entity, comprising: receiving, via a wireless communications link, a first message comprising a request for a UE to host a first service, wherein the first message further comprises resource record information associated with a domain name of the first service; communicating, with a second management entity and in accordance with the resource record information for the domain name, to verify whether the UE is associated with a subscription to host the first service; and transmitting, responsive to the first message, a second message that indicates whether the request for the UE to host the first service is accepted, wherein the first service is associated with a first IP address that corresponds to a first PDU session established at the UE.

Aspect 14: The method of aspect 13, further comprising: establishing, via the wireless communications link, the first PDU session, wherein the first message comprises a PDU session establishment request message or comprises a PDU session modification request message.

Aspect 15: The method of aspect 14, further comprising: transmitting, responsive to the PDU session establishment request message or the PDU session modification request message, an indication that the first IP address is associated with the first service.

Aspect 16: The method of any of aspects 13 through 15, further comprising: establishing a charging association for the first service in accordance with verifying that the UE is associated with the subscription to host the first service, wherein transmitting the second message is responsive to establishing the charging association.

Aspect 17: The method of any of aspects 13 through 16, further comprising: establishing a SDF, a QoS data flow, or both associated with the first service in accordance with verifying that the UE is associated with the subscription to host the first service, wherein transmitting the second message is responsive to establishing the SDF, the QoS data flow, or both.

Aspect 18: The method of any of aspects 13 through 17, further comprising: transmitting, to a DNS server associated with the UE and in response to transmitting the second message, a third message comprising an indication to add the resource record information to the DNS server; and receiving, from the DNS server, a message acknowledging that the resource record information has been added to the DNS server in response to transmitting the third message.

Aspect 19: The method of any of aspects 13 through 18, further comprising: receiving a fifth message that comprises modified resource record information for the domain name of the first service, the modified resource record information associating the domain name of the first service with a second IP address of a second PDU session.

Aspect 20: The method of any of aspects 13 through 19, wherein the first message comprises an indication of a time window associated with an availability of the first service at the UE.

Aspect 21: The method of any of aspects 13 through 20, wherein the first message comprises a second request to host a second service at the UE and comprises second resource record information associated with a second domain name of the second service, and the second message further indicates whether the second request to host the second service is accepted.

Aspect 22: The method of any of aspects 13 through 21, wherein the resource record information comprises the first IP address, a port number associated with the first service, a protocol type associated with the first service, a priority value associated with the first service, a weight value associated with the first service, or any combination thereof.

Aspect 23: The method of any of aspects 13 through 22, wherein the first service comprises an application layer service, a web service, a gaming service, a peer-to-peer service, a life broadcast service, an artificial intelligence compute service, or any combination thereof, and the first service uses a hyper text transfer protocol, a real-time transport protocol, or a real-time transport control protocol.

Aspect 24: A UE for wireless communications, comprising one or more memories storing processor-executable code, and one or more processors coupled with the one or more memories and individually or collectively operable to execute the code to cause the UE to perform a method of any of aspects 1 through 12.

Aspect 25: A UE for wireless communications, comprising at least one means for performing a method of any of aspects 1 through 12.

Aspect 26: A non-transitory computer-readable medium storing code for wireless communications, the code comprising instructions executable by one or more processors to perform a method of any of aspects 1 through 12.

Aspect 27: A management entity for wireless communications, comprising one or more memories storing processor-executable code, and one or more processors coupled with the one or more memories and individually or collectively operable to execute the code to cause the management entity to perform a method of any of aspects 13 through 23.

Aspect 28: A management entity for wireless communications, comprising at least one means for performing a method of any of aspects 13 through 23.

Aspect 29: A non-transitory computer-readable medium storing code for wireless communications, the code comprising instructions executable by one or more processors to perform a method of any of aspects 13 through 23.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, via a wireless communications link, a first message comprising a request for the UE to host a first service, wherein the first message further comprises resource record information associated with a domain name of the first service;
receive, responsive to the first message, a second message that indicates whether the request for the UE to host the first service is accepted;
receive, in accordance with the request being accepted and via a first internet protocol address that corresponds to a first protocol data unit session established at the UE, a third message from a client device that is associated with the first service hosted at the UE; and
transmit, responsive to the third message and via the first internet protocol address, a fourth message associated with the first service to the client device.

2. The UE of claim 1, wherein the one or more processors are individually or collectively further operable to execute the code to cause the UE to:
establish, via the wireless communications link, the first protocol data unit session, wherein the first message comprises a protocol data unit session establishment request message or comprises a protocol data unit session modification request message.

3. The UE of claim 2, wherein the one or more processors are individually or collectively further operable to execute the code to cause the UE to:
receive, responsive to the protocol data unit session establishment request message or the protocol data unit session modification request message, an indication that the first internet protocol address is associated with the first service.

4. The UE of claim 1, wherein the one or more processors are individually or collectively further operable to execute the code to cause the UE to:
receive, as part of a protocol data unit session establishment procedure, a prefix for an internet protocol address associated with the first protocol data unit session; and
select the first internet protocol address for the first service according to the prefix for the internet protocol address, wherein the resource record information comprises the first internet protocol address associated with the first service.

5. The UE of claim 1, wherein, to receive the third message, the one or more processors are individually or collectively further operable to execute the code to cause the UE to:
receive, from the client device, a transport layer setup request message to establish a first transport layer between the client device and the UE.

6. The UE of claim 1, wherein the one or more processors are individually or collectively further operable to execute the code to cause the UE to:
receive, as part of a protocol data unit session establishment procedure or a protocol data unit session modification procedure for the first protocol data unit session, an indication of a second internet protocol address of a local domain name system server, wherein the first message comprises a second request for the resource record information to be hosted at the local domain name system server, and wherein the first message comprises an indication of the second internet protocol address.

7. The UE of claim 1, wherein the one or more processors are individually or collectively further operable to execute the code to cause the UE to:
transmit a fifth message that comprises modified resource record information for the domain name of the first service, the modified resource record information associating the domain name of the first service with a second internet protocol address of a second protocol data unit session; and
receive, via the second internet protocol address, a sixth message from the client device that is associated with the first service hosted at the UE.

8. The UE of claim 7, wherein transmitting the fifth message is in response to a mobility of the UE.

9. The UE of claim 1, wherein the first message comprises an indication of a time window associated with an availability of the first service at the UE, and wherein transmitting the fourth message is in response to the third message being received within the time window.

10. The UE of claim 1, wherein the first message comprises a second request to host a second service at the UE and comprises second resource record information associated with a second domain name of the second service, and wherein the second message further indicates whether the second request to host the second service is accepted.

11. The UE of claim 1, wherein the resource record information comprises the first internet protocol address, a port number associated with the first service, a protocol type associated with the first service, a priority value associated with the first service, a weight value associated with the first service, or any combination thereof.

12. The UE of claim 1, wherein the first service comprises an application layer service, a web service, a gaming service, a peer-to-peer service, a life broadcast service, an artificial intelligence compute service, or any combination thereof, and the first service uses a hyper text transfer protocol, a real-time transport protocol, or a real-time transport control protocol.

13. A management entity, comprising:
one or more memories storing processor-executable code; and
one or more processors coupled with the one or more memories and individually or collectively operable to execute the code to cause the management entity to:
receive, via a wireless communications link, a first message comprising a request for a user equipment (UE) to host a first service, wherein the first message further comprises resource record information associated with a domain name of the first service;
communicate, with a second management entity and in accordance with the resource record information for the domain name, to verify whether the UE is associated with a subscription to host the first service; and
transmit, responsive to the first message, a second message that indicates whether the request for the UE to host the first service is accepted, wherein the first service is associated with a first internet protocol address that corresponds to a first protocol data unit session established at the UE.

14. The management entity of claim 13, wherein the one or more processors are individually or collectively further operable to execute the code to cause the management entity to:
establish, via the wireless communications link, the first protocol data unit session, wherein the first message comprises a protocol data unit session establishment request message or comprises a protocol data unit session modification request message.

15. The management entity of claim 14, wherein the one or more processors are individually or collectively further operable to execute the code to cause the management entity to:
transmit, responsive to the protocol data unit session establishment request message or the protocol data unit session modification request message, an indication that the first internet protocol address is associated with the first service.

16. The management entity of claim 13, wherein the one or more processors are individually or collectively further operable to execute the code to cause the management entity to:
establish a charging association for the first service in accordance with verifying that the UE is associated with the subscription to host the first service, wherein transmitting the second message is responsive to establishing the charging association.

17. The management entity of claim 13, wherein the one or more processors are individually or collectively further operable to execute the code to cause the management entity to:
establish a service data flow, a quality of service data flow, or both associated with the first service in accordance with verifying that the UE is associated with the subscription to host the first service, wherein transmitting the second message is responsive to establishing the service data flow, the quality of service data flow, or both.

18. The management entity of claim 13, wherein the one or more processors are individually or collectively further operable to execute the code to cause the management entity to:
transmit, to a domain name system server associated with the UE and in response to transmitting the second message, a third message comprising an indication to add the resource record information to the domain name system server; and
receive, from the domain name system server, a message acknowledging that the resource record information has been added to the domain name system server in response to transmitting the third message.

19. The management entity of claim 13, wherein the one or more processors are individually or collectively further operable to execute the code to cause the management entity to:
receive a fifth message that comprises modified resource record information for the domain name of the first service, the modified resource record information associating the domain name of the first service with a second internet protocol address of a second protocol data unit session.

20. The management entity of claim 13, wherein the first message comprises an indication of a time window associated with an availability of the first service at the UE.

21. The management entity of claim 13, wherein the first message comprises a second request to host a second service at the UE and comprises second resource record information associated with a second domain name of the second service, and wherein the second message further indicates whether the second request to host the second service is accepted.

22. The management entity of claim 13, wherein the resource record information comprises the first internet protocol address, a port number associated with the first service, a protocol type associated with the first service, a priority value associated with the first service, a weight value associated with the first service, or any combination thereof.

23. The management entity of claim 13, wherein the first service comprises an application layer service, a web service, a gaming service, a peer-to-peer service, a life broadcast service, an artificial intelligence compute service, or any combination thereof, and wherein the first service uses a hyper text transfer protocol, a real-time transport protocol, or a real-time transport control protocol.

24. A method for wireless communications by a user equipment (UE), comprising:
transmitting, via a wireless communications link, a first message comprising a request for the UE to host a first service, wherein the first message further comprises resource record information associated with a domain name of the first service;
receiving, responsive to the first message, a second message that indicates whether the request for the UE to host the first service is accepted;
receiving, in accordance with the request being accepted and via a first internet protocol address that corresponds to a first protocol data unit session established at the UE, a third message from a client device that is associated with the first service hosted at the UE; and
transmitting, responsive to the third message and via the first internet protocol address, a fourth message associated with the first service to the client device.

25. The method of claim 24, further comprising:
establishing, via the wireless communications link, the first protocol data unit session, wherein the first message comprises a protocol data unit session establishment request message or comprises a protocol data unit session modification request message.

26. The method of claim 25, further comprising:
receiving, responsive to the protocol data unit session establishment request message or the protocol data unit session modification request message, an indication that the first internet protocol address is associated with the first service.

27. The method of claim 24, further comprising:
receiving, as part of a protocol data unit session establishment procedure, a prefix for an internet protocol address associated with the first protocol data unit session; and
selecting the first internet protocol address for the first service according to the prefix for the internet protocol address, wherein the resource record information comprises the first internet protocol address associated with the first service.

28. The method of claim 24, wherein receiving the third message further comprises:
receiving, from the client device, a transport layer setup request message to establish a first transport layer between the client device and the UE.

29. The method of claim 24, further comprising:
receiving, as part of a protocol data unit session establishment procedure or a protocol data unit session modification procedure for the first protocol data unit session, an indication of a second internet protocol address of a local domain name system server, wherein the first message comprises a second request for the resource record information to be hosted at the local domain name system server, and wherein the first message comprises an indication of the second internet protocol address.

30. A method for wireless communications by a management entity, comprising:
receiving, via a wireless communications link, a first message comprising a request for a user equipment (UE) to host a first service, wherein the first message further comprises resource record information associated with a domain name of the first service;
communicating, with a second management entity and in accordance with the resource record information for the domain name, to verify whether the UE is associated with a subscription to host the first service; and
transmitting, responsive to the first message, a second message that indicates whether the request for the UE to host the first service is accepted, wherein the first service is associated with a first internet protocol address that corresponds to a first protocol data unit session established at the UE.
